(19) United States
(12) Patent Application Publication
(10) Pub. No.: US 2005/0043974 A1
(43) Pub. Date: Feb. 24, 2005

(54) Bounded flexibility search and interface for travel reservations

(76) Inventors: Assen Vassilev, Cambridge, MA (US); Stanislav B. Gyoshev, Philadelphia, PA (US)

Correspondence Address: ORRICK, HERRINGTON & SUTCLIFFE, LLP, 4 PARK PLAZA, SUITE 1600, IRVINE, CA, 92614-2558, US

(21) Appl. No.: 10/826,928

(22) Filed: Apr. 15, 2004

Related U.S. Application Data
(60) Provisional application No. 60/463,466, filed on Apr. 16, 2003.

(51) Int. Cl. G06F 17/60

(52) U.S. Cl. 705/5

(57) ABSTRACT

A system and method for selecting travel products, including but not limited to a system having a plurality of selection rules that enable the user to rapidly select the best travel product by using range searches for all search criteria.

This application claims the benefit of U.S. Provisional Application Ser. No. 60/463,466, filed Apr. 16, 2003.

### FIELD OF THE INVENTION

The present invention relates generally to the field of selecting travel products, and more specifically to a system and method of selecting travel products including range searches for all search criteria.

### BACKGROUND OF THE INVENTION

Suppliers of travel products, such as package vacations, airplane flights, and hotels, have developed a distribution system used by travel agents to help travelers select a particular travel product. Information is delivered to the traveler in several different ways. Travelers can solicit the services of a travel agent who usually uses one of several universal search platforms (e.g. Sabre, Amadeus) and checks for availability and fare information on a particular route and set of dates the traveler is interested in. Alternatively, travelers can call the reservation desk of an airline company and receive a potentially broader selection of fares that, however, is limited to the services that the airline in question and its partners and affiliates offer. A third, recently introduced option is for the traveler to visit either an online travel agent (e.g. Expedia, Travelocity) or an airline website and perform an availability and fare search directly on the Internet.

Currently there are two types of searches available across all these modes of distribution of travel related services. The first type requires the input of specific travel dates, origin and destination and displays all available fares that meet the criteria specified and are in the travel database that is searched. This search is widely available and is usually termed “schedule search.” The limitations of this search are that if a traveler has flexible travel plans the search cannot practically show all the options that meet the traveler's criteria and let the traveler choose the best option. Take for example a typical spring break traveler who wishes to travel from Boston to Western Europe, departing between 5 pm on March 20 until March 22 and returning between March 29 until noon on April 1, spending at least 9 days in Western Europe. If that traveler uses a schedule search, they will have to perform over 2,000 searches, manually eliminate flight times that do not fit their schedule on March 20 and April 1 and sort by best available price. This is not only impractical (at five minutes per search it requires 167 hours) but also impossible to do since airline seat availability and fare information is updated at least every fifteen minutes. Most travelers and travel agents look at several more popular options and choose the best alternative, disregarding alternatives that have not been explored (e.g. the spring break travelers discussed will probably not look at airfares to Dusseldorf and therefore may potentially miss a lower fare that gets him right at heart of Western Europe).

The second type of search available requires the input only of an origin and destination and returns a list of all fares offered between the two points of travel. While this allows travelers to quickly compare alternative routes (e.g. Boston-London, Boston-Paris, Boston-Milan), it does not guarantee that any of the displayed fares will actually be available on the particular dates the traveler wishes to travel. Most travel reservation systems (e.g. Travelocity) usually request the traveler to choose a particular fare and then show calendars with days when that particular fare is available. As a second step the traveler has to choose his desired date of departure and return at which point the system checks for seat availability and either makes the reservation or returns a message that there are no seats available. Given that significant number of the cheaper fares are limited to travel only on particular days of the week and that availability for them is fairly limited, booking a ticket in this way usually requires the traveler to check several fares before being able to find travel arrangements that meet his timing constraints. In addition, once the cheapest fare on a particular routing is not available, the traveler usually has to reprioritize his choice of destinations and see whether some other destination is not now cheaper to travel to. Thus, in order to find the best fare, a traveler must check a number days on a number of fares on a number of routings. The spring break traveler in the above example will have to check nine departure date/arrival date combinations on average of three to five fares across fifty destinations. That results in between 1,350 and 2,250 searches, which again makes performing an exhaustive search to find the best alternative not only impractical but also impossible due to changes in seat availability and fare information.

### SUMMARY OF THE INVENTION

The present invention is an alternative search type applicable to all modes of distribution of travel related services. Unlike both the schedule and the fares offered searches, the system and method of the present invention makes travel plans reservations convenient and less time-consuming through a bounded flexibility search, allowing travelers to enter information in a range rather than a point-to-point format. In one preferred embodiment, the present invention introduces a new type of travel search that enables the user to perform an exhaustive search of travel alternatives over the entire range of their flexibility along different criteria (e.g. travel dates and times, geographies, length of stay). In another preferred embodiment, the invention is a method for segmenting the travel market and customizing the search interface across different customer segments.

### BRIEF DESCRIPTION OF THE DRAWING

The invention is described with reference to the several figures of the drawing, in which,

FIG. 1a depicts an interface using point-to-point range searches;

FIG. 1b depicts an interface using geography range searches;

FIG. 2a is a process flow chart illustrating the process of compiling, receiving, and sorting travel data during a point-to-point range search;

FIG. 2b is a process flow chart illustrating the process of compiling, receiving, and sorting travel data during a geography range search;

FIG. 3.1 is a process flow chart illustrating the process of customization of the search interface for an existing customer;

FIG. 3.2 is a process flow chart illustrating the process of customization of the search interface for a new customer; and

FIG. 4 depicts an interface for date range searches.

### DETAILED DESCRIPTION

Referring now to the figures of the drawing, the figures constitute a part of this specification and illustrate exemplary embodiments to the invention. It is to be understood that in some instances various aspects of the invention may be shown exaggerated or enlarged to facilitate an understanding of the invention.

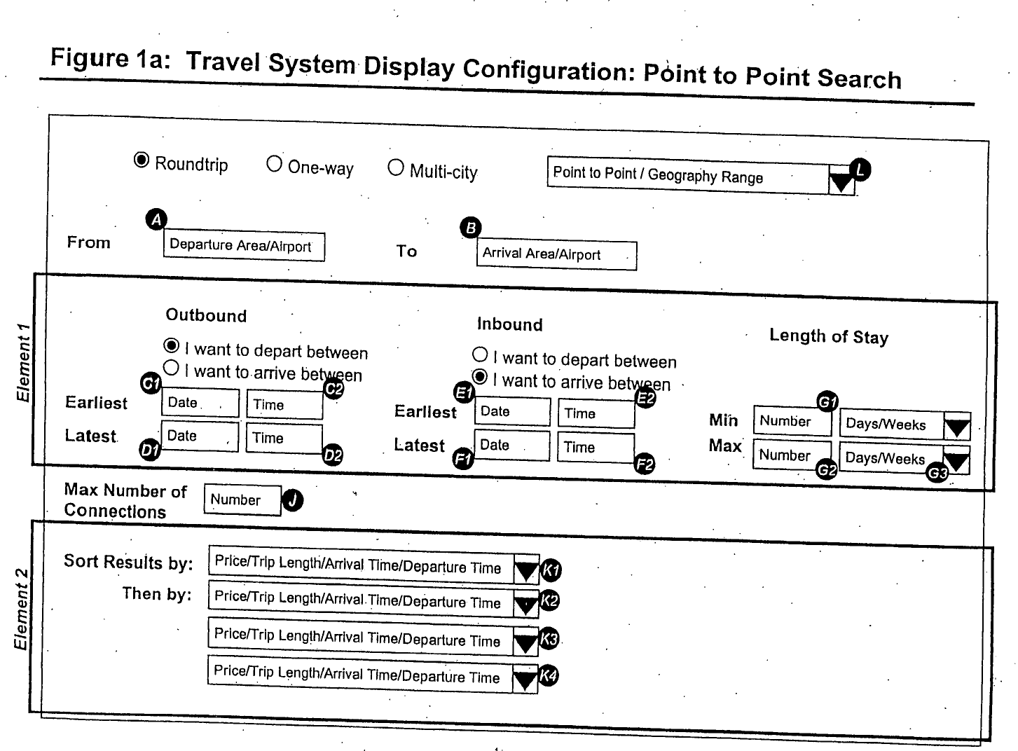

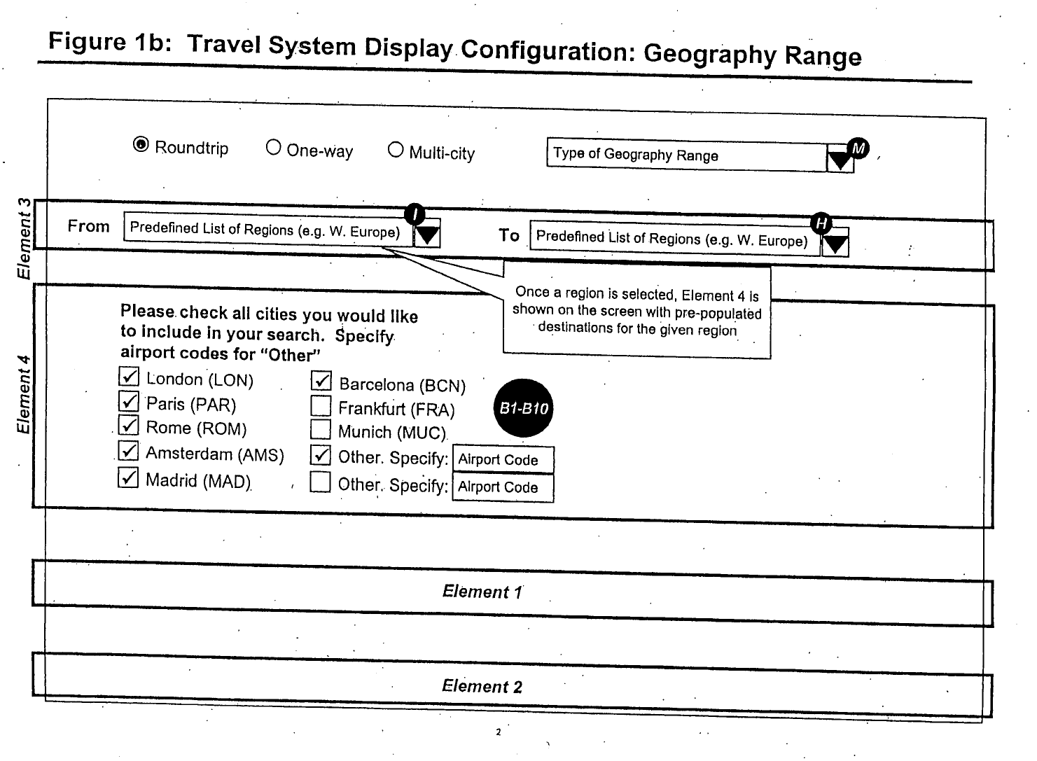

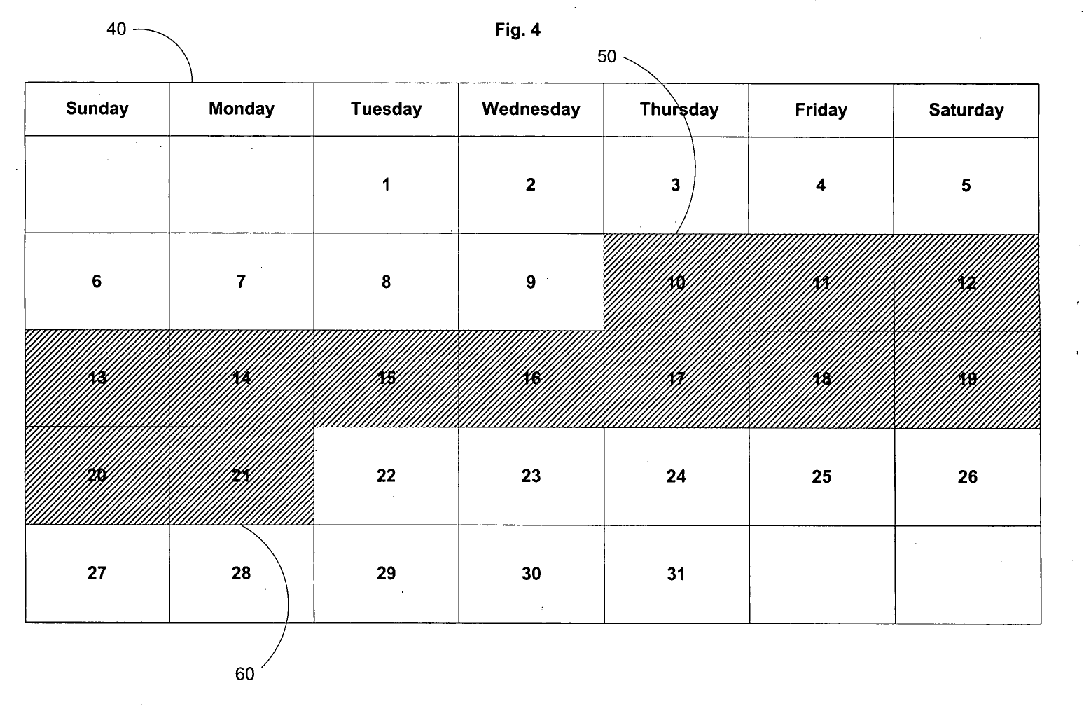

The present invention discloses an apparatus and method for providing a plurality of alternative travel itineraries based on geography and time range searches and allowing the user to select the best air travel product for them. In one embodiment of the present invention, the user can choose to execute a point-to-point or geography range search by selecting the search type from the user interface menu (see FIG. 1a, Field L). FIG. 1a shows an interface using point-to-point range searches. Point-to-point search refers to a range search where the origination and destination are single points (e.g. Boston to London) rather than ranges (e.g. New England to Western Europe). FIG. 1a describes the interface for collecting the information necessary to conduct a point-to-point range search. The origin and destination information is collected in Fields A and B. The maximum connections information is collected in Field J. The information on the timing flexibility of the trip is collected in Element 1, which consists of three sections: outbound flight, inbound flight and length of stay. In one aspect, the traveler has the option to choose whether the times and dates he is providing for the inbound flight are departure or arrival times and dates. For example, if a traveler wants to depart between 10 am and 1 pm on March 21, he will choose “I want to depart between” and fill in the corresponding dates and times. If, however, the traveler wants to arrive at his destination between 10 am and 1 pm on March 21, he will choose “I want to arrive between” and fill in the corresponding dates and times. After specifying whether the travel must originate or end in a particular time interval, the traveler enters the dates and times that describe the time interval during which he is willing to travel (see FIG. 1a, Fields C1, C2, D1 and D2). Alternatively, instead of, or in addition to, entering the dates and times in Fields C1, C2, D1, and D2, the traveler may also specify the dates and times by highlighting the dates and times with a user interface that includes a graphical depiction of a calendar 40, as shown in FIG. 4. Whether the traveler wants to specify an outbound date range or an inbound date range, the traveler can simply “click” on the earliest and latest dates 50, 60. Likewise, the same information is collected for the inbound flight. In another aspect, the traveler has the opportunity to specify a range for the desired length of stay at their destination (see FIG. 1a, Fields G1, G2 and G3).

In one aspect, information on preferences about sorting of results is collected from the user (see FIG. 1a, Element 2). The traveler is requested to sequentially rank sorting criteria for the results of the searches in a series of pull-down menus (see FIG. 1a, Fields K1-K4). The sorting criteria may include, for example, price, trip length, departure date and time, arrival date and time, mileage, number of connects, or airline.

In another preferred embodiment, the user selects from various geography range searches. FIG. 1b shows an interface using geography range searches. In this embodiment, FIG. 1b, Element 3 replaces FIG. 1a, Fields A and B. In one aspect, the user chooses a point-to-range search. In this aspect, the user chooses a departure area/airport and a predefined list of arrival regions (see Element 3 containing Fields A and H). In another aspect, the user chooses a range-to-range search. In this aspect, the user chooses a predefined list of departure regions and a predefined list of arrival regions (see Element 3 containing Fields I and B). In a final aspect, the user chooses a range-to-point search. In this aspect, the user chooses a predefined list of departure regions and an arrival area/airport (see Element 3 contains Fields I and H). In one embodiment, the predefined list of departure and arrival regions are selected from a pull-down menu (see Fields I and J). Note that “region,” as it is used herein, need not imply a contiguous geographic region, but may include any set of airports or other locations that a user might wish to search on simultaneously.

If the user selects at least one predefined departure or arrival region, the system displays a list of available airports within that predefined region (see Element 4). In one embodiment, the user selects a range-to-range search in which the system displays a list of available airports within both the predefined departure and arrival destination. In one aspect, the system displays a number of pre-populated airports or cities to/from which he can travel. In another aspect, the system displays open positions in which the user can specify airports or cities not already on the list. FIG. 1b, Element 4 shows a list of ten cities in total with eight pre-populated cities and two open positions. The user can select and deselect as many cities as they want to specify in their search. In one aspect, the user can select “all” or “none.” Selecting “none” would clear the selection for the user to start with nothing selected.

In another preferred embodiment, the interface continues to collect information from the user about time flexibility and sorting preferences as described in the point-to-point search.

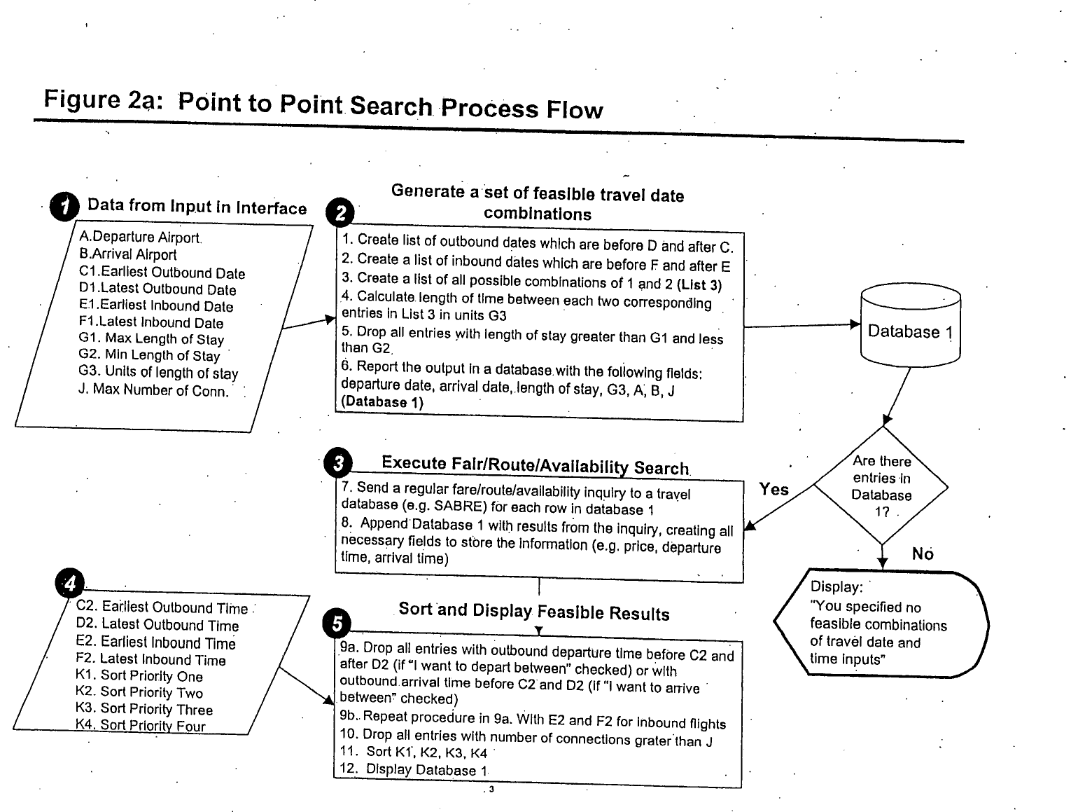

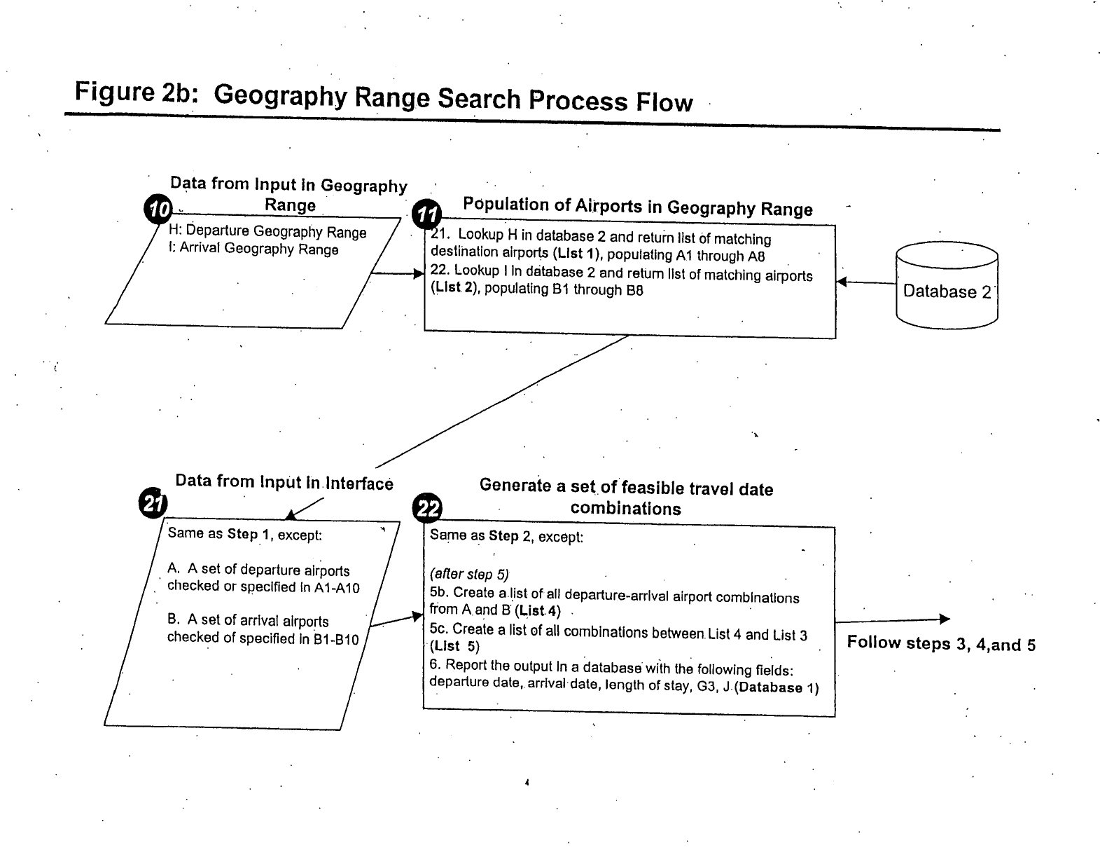

FIG. 2a illustrates the present invention's system point-to-point search flow of information processing and the display of results. In one preferred embodiment of the present invention, the system generates a set of feasible combinations of departure-arrival airports generated from a point-to-point search (see List 3) including: a list of outbound dates that are before the latest departing date (see D1) and after the earliest departing date (see C1) and a list of inbound dates that are before the latest arrival date (see F1) and after the earliest arrival date (see E1). The length of stay between two corresponding entries in the list of feasible combinations is calculated. All entries with a length of stay greater than maximum number of days or weeks specified by the user or less than the minimum number of days or weeks specified by the user is eliminated from the list of feasible combinations. In one aspect, the output of feasible combinations is reported in a database (see Database 1) with at least the following fields: departure date, arrival date, inputted length of stay, calculated length of stay of each combination, departure area/airport, arrival area/airport and maximum number of combinations. In another aspect, if there are no feasible entries, the user is notified by the system with a message to that effect. For example, the system may return a message stating “You specified no feasible combinations of travel date and time inputs.”

After the information is stored into an initial database (see Database 1), the system sends a regular fare/route/availability inquiry to a travel database (e.g. SABRE) for each row of information stored in the initial database. The initial database is amended with the results from the inquiry, creating all necessary fields to store the information (e.g. price, departure time, arrival time).

In one aspect, entries with an outbound departure time listed before the earliest departure time or after the latest departure time inputted by the user are eliminated from the database. Entries with an outbound arrival time listed before the earliest arrival time or after the latest arrival time inputted by the user are eliminated from the database. Similarly, entries with an inbound departure time listed before the earliest departure time or after the latest departure time inputted by the user are eliminated from the database. Entries with an inbound arrival time listed before the earliest arrival time or after the latest arrival time inputted by the user are eliminated from the database.

In another aspect, all entries with a number of connections greater than those specified by the user are eliminated.

Finally, information still remaining is sorted by preferences selected by the user sequentially (see K1, K2, K3, and K4) and is displayed to the user.

FIG. 2b illustrates the present invention's system geography range search flow of information processing and the display of results. In one preferred embodiment of the present invention, the system generates a set of feasible combinations of departure-arrival airports generated from a geography range-to-range search wherein the user selects departure and arrival geography ranges. The system queries an information database (see Database 2) for airports within the selected departure and arrival geography ranges and returns airport information to be displayed to the user. In one aspect, the user selects airports from a number of pre-populated airports or cities to/from which he can travel. In another aspect, the the user can specify airports or cities not already on the list in open positions. The user can select and deselect as many cities as they want to specify in their search. In one aspect, the user can select “all” or “none.” Selecting “none” would clear the selection for the user to start with nothing selected.

In one aspect of this embodiment, the system generates a set of feasible combinations of departure-arrival airports generated from a range-to-range search (see List 5) including: a list of outbound dates that are before the latest departing date (see D1) and after the earliest departing date (see C1), a list of inbound dates that are before the latest arrival date (see F1) and after the earliest arrival date (see E1), and a list of all feasible combinations between departure-arrival airport combinations and outbound and inbound dates combinations (see List 4). The length of stay between two corresponding entries in the list of feasible combinations is calculated. All entries with a length of stay greater than maximum number of days or weeks specified by the user or less than the minimum number of days or weeks specified by the user is eliminated from the list of feasible combinations. In one aspect, the output of feasible combinations is reported in a database (see Database 1) with at least the following fields: departure date, arrival date, inputted length of stay, calculated length of stay of each combination, departure area/airport, arrival area/airport and maximum number of combinations. In another aspect, if there are no feasible entries, the user is notified by the system with a message to that effect. For example, the system may return a message stating “You specified no feasible combinations of travel date and time inputs.”

After the information is stored into an initial database (see Database 1), the system sends a regular fare/route/availability inquiry to a travel database (e.g. SABRE) for each row of information stored in the initial database. The initial database is amended with the results from the inquiry, creating all necessary fields to store the information (e.g. price, departure time, arrival time).

In one aspect, entries with an outbound departure time listed before the earliest departure time or after the latest departure time inputted by the user are eliminated from the database. Entries with an outbound arrival time listed before the earliest arrival time or after the latest arrival time inputted by the user are eliminated from the database. Similarly, entries with an inbound departure time listed before the earliest departure time or after the latest departure time inputted by the user are eliminated from the database. Entries with an inbound arrival time listed before the earliest arrival time or after the latest arrival time inputted by the user are eliminated from the database.

In another aspect, all entries with a number of connections greater than those specified by the user are eliminated.

Finally, information still remaining is sorted by preferences selected by the user sequentially (see K1, K2, K3, and K4) and is displayed to the user.

In a preferred embodiment, the user can access a remotely accessible source for making travel destination reservations. In other preferred embodiments of the present invention, the user can search the system for hotels, car rental services, railroad travel, bus travel and other travel-related availability or prices.

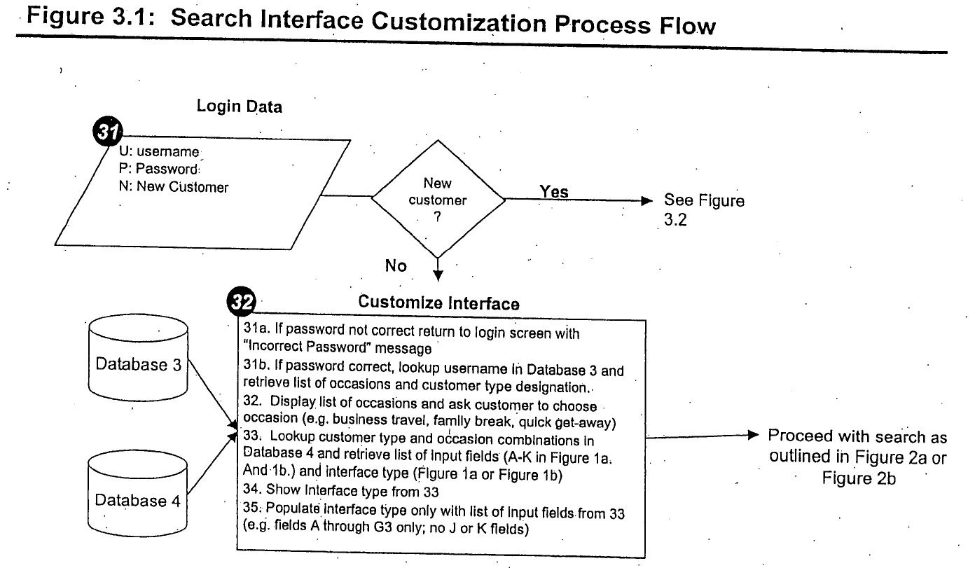

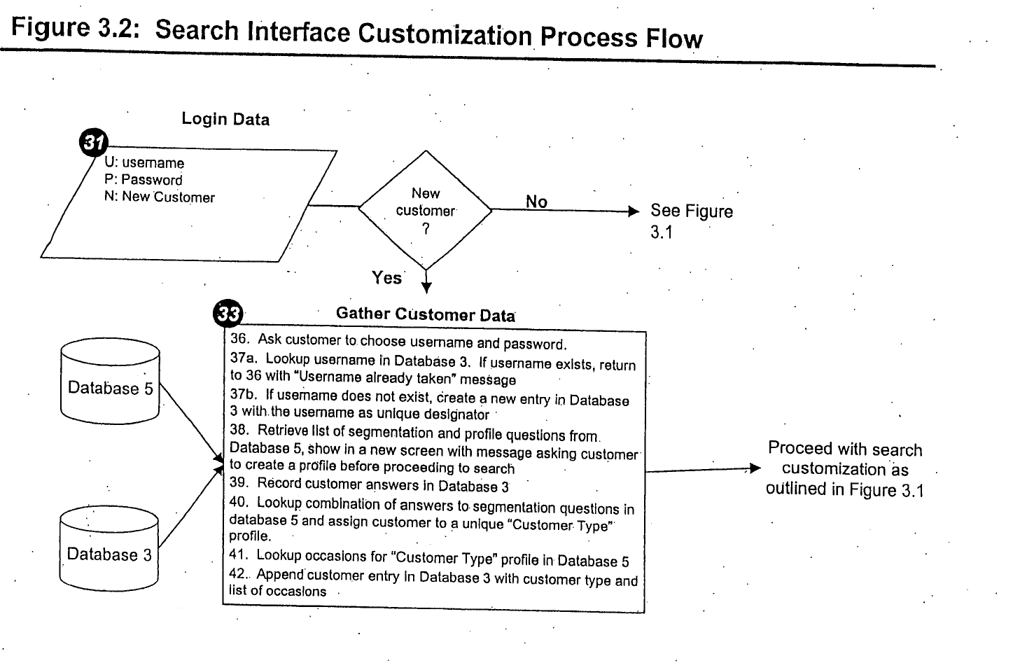

In another embodiment of the present invention, the method and system incorporates a search interface customization. FIG. 3.1 and FIG. 3.2 illustrate the process flow of a search interface customization. In one aspect, the system queries the user for information regarding their customer status. The user may input that they are a new customer or returning customer. If the user is a new customer, the system queries the user to select and input a username and password (see FIG. 3.2). The system looks up the username in a database (ex. Database 3) and determines whether this username has been secured by another customer. If so, the system returns a message to the login screen to that effect (ex. “Username Already Taken”). If the username has not been secured by another customer, the system creates a new entry in the database (Database 3) with the username as the unique designator. The system then retrieves a list of segmentation and profile questions from another database (ex. Database 5), displays these questions and queries the user to create a profile by answering the questions, before proceeding to a search. The user's answers are stored in the database (Database 3). In another aspect, the system looks up the combination of answers to the segmentation and profile questions in a database (ex. Database 5) and assigns the user to a unique “Customer Type” profile. The system then looks up occasions for the “Customer Type” (ex. in Database 5) and appends the user information stored (ex. in Database 3) with “Customer Type” and list of occasions information.

If the user is a returning customer, the system queries the user for a previously established username and password (see FIG. 3.1). If the information is entered incorrectly, the system returns a message to the login screen to that effect (ex. “Incorrect Password”). If the information is entered correctly, the system looks up the username in a database (ex. Database 3) and retrieves a list of occasions and customer type designations. The system displays a list of occasions (e.g. business travel, family break, quick get-away) and queries the user to choose at least one. Once the occasion is selected, an associated set of preferences can be used to customize the search.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

1. A method of searching travel products and providing a plurality of alternative travel itineraries to the user comprising:
querying the user for a first set of input data, the input data being at least one departure airport or geography range and at least one arrival geography range associated with the travel departure and arrival;
searching the information storage and retrieval system for travel departure and arrival information corresponding to the first set of input data;
displaying the information associated with the selected travel departure and arrival information, including a list of at least one departure airport selected or within the selected travel departure geography and a list of at least one arrival airport within the selected travel arrival geography;
querying the user for exact departure and arrival dates and times, a range of acceptable departure and arrival dates and times or a range of an acceptable length of stay;
querying a travel database comprising travel data including separately maintained travel schedule data items, fare data items, and fare limitation information for matching itineraries with all possible departure and arrival airport, date, time, length of stay, and number of connections combinations; and
displaying the information associated with the travel departure and arrival.

2. The method of claim 1, further comprising querying the user for a second set of input data, the second set of input data including selecting at least one acceptable departure airport and at least one acceptable arrival airport associated with the travel departure and arrival.

3. The method of claim 1, further comprising querying the user for an acceptable maximum number of connections.

4. The method of claim 1, further comprising querying the user for an acceptable means of sorting and displaying the results of the travel database query.

5. The method of claim 1, further comprising accessing a remotely accessible source for making travel destination reservations.

6. The method of claim 1, further comprising making a reservation at a selected travel destination using the remotely accessed source for making travel destination reservations.

7. A method of searching travel products and providing a plurality of alternative travel itineraries to the user comprising:
querying the user for a first set of input data, the input data being at least one departure geography range and at least one arrival airport or geography range associated with the travel departure and arrival;
searching the information storage and retrieval system for travel departure and arrival information corresponding to the first set of input data;
displaying the information associated with the selected travel departure and arrival information, including a list of at least one departure airport within the selected travel departure geography and a list of at least one arrival airport selected or within the selected travel arrival geography;
querying the user for exact arrival departure and arrival dates and times, a range of acceptable departure and arrival dates and times or a range of an acceptable length of stay;
querying a travel database comprising travel data including separately maintained travel schedule data items, fare data items, and fare limitation information for matching itineraries with all possible departure and arrival airport, date, time, length of stay, and number of connections combinations; and
displaying the information associated with the travel departure and arrival.

8. The method of claim 7, further comprising querying the user for a second set of input data, the second set of input data including selecting at least one acceptable departure airport and at least one acceptable arrival airport associated with the travel departure and arrival.

9. The method of claim 7, further comprising querying the user for an acceptable maximum number of connections.

10. The method of claim 7, further comprising querying the user for an acceptable means of sorting and displaying the results of the travel database query.

11. The method of claim 7, further comprising accessing a remotely accessible source for making travel destination reservations.

12. The method of claim 7, further comprising making a reservation at a selected travel destination using the remotely accessed source for making travel destination reservations.

13. A system of searching travel products and providing a plurality of alternative travel itineraries to the user comprising:
querying means for querying the user for input data, the input data being at least one departure airport or geography range and at least one arrival geography range associated with the travel departure and arrival;
searching means for searching the information storage and retrieval system for travel departure and arrival information corresponding to the first set of input data;
displaying means for displaying the information associated with the selected travel departure and arrival information, including a list of at least one departure airport selected or within the selected travel departure geography and a list of at least one arrival airport within the selected travel arrival geography;
querying means for querying the user for exact departure and arrival dates and times, a range of acceptable departure and arrival dates and times or a range of an acceptable length of stay;
querying means for querying a travel database comprising travel data including separately maintained travel schedule data items, fare data items, and fare limitation information for matching itineraries with all possible departure and arrival airport, date, time, length of stay, and number of connections combinations; and
displaying means for displaying the information associated with the travel departure and arrival.

14. The system of claim 13, further comprising querying means for querying the user for a second set of input data, the second set of input data including selecting at least one acceptable departure airport and at least one acceptable arrival airport associated with the travel departure and arrival.

15. The system of claim 13, further comprising querying means for querying the user for an acceptable maximum number of connections.

16. The system of claim 13, further comprising querying means for querying the user for an acceptable means of sorting and displaying the results of the travel database query.

17. The system of claim 13, further comprising accessing means for accessing a remotely accessible source for making travel destination reservations.

18. The system of claim 13, further comprising reservation means for making a reservation at a selected travel destination using the remotely accessed source for making travel destination reservations.

19. A system of searching travel products and providing a plurality of alternative travel itineraries to the user comprising:
querying means for querying the user for a first set of input data, the input data being at least one departure geography range and at least one arrival airport or geography range associated with the travel departure and arrival;
searching means for searching the information storage and retrieval system for travel departure and arrival information corresponding to the first set of input data;
displaying means for displaying the information associated with the selected travel departure and arrival information, including a list of at least one departure airport within the selected travel departure geography and a list of at least one arrival airport selected or within the selected travel arrival geography;
querying means for querying the user for exact departure and arrival dates and times, a range of acceptable departure and arrival dates and times or a range of an acceptable length of stay;
querying means for querying a travel database comprising travel data including separately maintained travel schedule data items, fare data items, and fare limitation information for matching itineraries with all possible departure and arrival airport, date, time, length of stay, and number of connections combinations; and
displaying means for displaying the information associated with the travel departure and arrival.

20. The system of claim 19, further comprising querying means for querying the user for a second set of input data, the second set of input data including selecting at least one acceptable departure airport and at least one acceptable arrival airport associated with the travel departure and arrival.

21. The system of claim 19, further comprising querying means for querying the user for an acceptable maximum number of connections.

22. The system of claim 19, further comprising querying means for querying the user for an acceptable means of sorting and displaying the results of the travel database query.

23. The system of claim 19, further comprising accessing means for accessing a remotely accessible source for making travel destination reservations.

24. The system of claim 19, further comprising reservation means for making a reservation at a selected travel destination using the remotely accessed source for making travel destination reservations.

25. A method of searching travel products and providing a plurality of alternative travel itineraries to the user comprising:
querying the user for a first set of input data, the input data being at least one departure airport or geography range and at least one arrival geography range associated with the travel departure and arrival;
searching the information storage and retrieval system for travel departure and arrival information corresponding to the first set of input data;
displaying the information associated with the selected travel departure and arrival information, including a list of at least one departure airport selected or within the selected travel departure geography and a list of at least one arrival airport within the selected travel arrival geography;
querying the user for a range of acceptable departure and arrival dates and times and a range of an acceptable length of stay;
querying a travel database comprising travel data including separately maintained travel schedule data items, fare data items, and fare limitation information for matching itineraries with all possible departure and arrival airport, date, time, length of stay, and number of connections combinations; and
displaying the information associated with the travel departure and arrival.

26. The method of claim 25, wherein a set of feasible combinations of departure dates and times and arrival dates and times is generated.

27. The method of claim 25, wherein a length of stay is calculated for each feasible combination.

28. The method of claim 25, wherein the feasible combinations with a length of stay greater than the maximum acceptable length of stay designated by the user is eliminated.

29. The method of claim 25, wherein the feasible combinations with a length of stay less than the minimum acceptable length of stay designated by the user is eliminated.

30. The method of claim 25, further comprising querying the user for a second set of input data, the second set of input data including selecting at least one acceptable departure airport and at least one acceptable arrival airport associated with the travel departure and arrival.

31. The method of claim 25, further comprising querying the user for an acceptable maximum number of connections.

32. The method of claim 25, further comprising querying the user for an acceptable means of sorting and displaying the results of the travel database query.

33. The method of claim 25, further comprising accessing a remotely accessible source for making travel destination reservations.

34. The method of claim 25, further comprising making a reservation at a selected travel destination using the remotely accessed source for making travel destination reservations.

35. A method of searching travel products and providing a plurality of alternative travel itineraries to the user comprising:
querying the user for a first set of input data, the input data being at least one departure geography range and at least one arrival airport or geography range associated with the travel departure and arrival;
searching the information storage and retrieval system for travel departure and arrival information corresponding to the first set of input data;
displaying the information associated with the selected travel departure and arrival information, including a list of at least one departure airport within the selected travel departure geography and a list of at least one arrival airport selected or within the selected travel arrival geography;
querying the user for a range of acceptable departure and arrival dates and times and a range of an acceptable length of stay;
querying a travel database comprising travel data including separately maintained travel schedule data items, fare data items, and fare limitation information for matching itineraries with all possible departure and arrival airport, date, time, length of stay, and number of connections combinations; and
displaying the information associated with the travel departure and arrival.

36. The method of claim 35, wherein a set of feasible combinations of departure dates and times and arrival dates and times is generated.

37. The method of claim 35, wherein a length of stay is calculated for each feasible combination.

38. The method of claim 35, wherein the feasible combinations with a length of stay greater than the maximum acceptable length of stay designated by the user is eliminated.

39. The method of claim 35, wherein the feasible combinations with a length of stay less than the minimum acceptable length of stay designated by the user is eliminated.

40. The method of claim 35, further comprising querying the user for a second set of input data, the second set of input data including selecting at least one acceptable departure airport and at least one acceptable arrival airport associated with the travel departure and arrival.

41. The method of claim 35, further comprising querying the user for an acceptable maximum number of connections.

42. The method of claim 35, further comprising querying the user for an acceptable means of sorting and displaying the results of the travel database query.

43. The method of claim 35, further comprising accessing a remotely accessible source for making travel destination reservations.

44. The method of claim 35, further comprising making a reservation at a selected travel destination using the remotely accessed source for making travel destination reservations.

45. A system of searching travel products and providing a plurality of alternative travel itineraries to the user comprising:
querying means for querying the user for a first set of input data, the input data being at least one departure airport or geography range and at least one arrival geography range associated with the travel departure and arrival;
searching means for searching the information storage and retrieval system for travel departure and arrival information corresponding to the first set of input data;
displaying means for displaying the information associated with the selected travel departure and arrival information, including a list of at least one departure airport selected or within the selected travel departure geography and a list of at least one arrival airport within the selected travel arrival geography;
querying means for querying the user for a range of acceptable departure and arrival dates and times and a range of an acceptable length of stay;
querying means for querying a travel database comprising travel data including separately maintained travel schedule data items, fare data items, and fare limitation information for matching itineraries with all possible departure and arrival airport, date, time, length of stay, and number of connections combinations; and
displaying means for displaying the information associated with the travel departure and arrival.

46. The system of claim 45, wherein a set of feasible combinations of departure dates and times and arrival dates and times is generated.

47. The system of claim 45, wherein a length of stay is calculated for each feasible combination.

48. The system of claim 45, wherein the feasible combinations with a length of stay greater than the maximum acceptable length of stay designated by the user is eliminated.

49. The system of claim 45, wherein the feasible combinations with a length of stay less than the minimum acceptable length of stay designated by the user is eliminated.

50. The system of claim 45, further comprising querying means for querying the user for a second set of input data, the second set of input data including selecting at least one acceptable departure airport and at least one acceptable arrival airport associated with the travel departure and arrival.

51. The system of claim 45, further comprising querying means for querying the user for an acceptable maximum number of connections.

52. The system of claim 45, further comprising querying means for querying the user for an acceptable means of sorting and displaying the results of the travel database query.

53. The system of claim 45, further comprising accessing means for accessing a remotely accessible source for making travel destination reservations.

54. The system of claim 45, further comprising reservation means for making a reservation at a selected travel destination using the remotely accessed source for making travel destination reservations.

55. A system of searching travel products and providing a plurality of alternative travel itineraries to the user comprising:
querying means for querying the user for a first set of input data, the input data being at least one departure geography range and at least one arrival airport or geography range associated with the travel departure and arrival;
searching means for searching the information storage and retrieval system for travel departure and arrival information corresponding to the first set of input data;
displaying means for displaying the information associated with the selected travel departure and arrival information, including a list of at least one departure airport within the selected travel departure geography and a list of at least one arrival airport selected or within the selected travel arrival geography;
querying means for querying the user for a range of acceptable departure and arrival dates and times and a range of an acceptable length of stay;
querying means for querying a travel database comprising travel data including separately maintained travel schedule data items, fare data items, and fare limitation information for matching itineraries with all possible departure and arrival airport, date, time, length of stay, and number of connections combinations; and
displaying means for displaying the information associated with the travel departure and arrival.

56. The system of claim 55, wherein a set of feasible combinations of departure dates and times and arrival dates and times is generated.

57. The system of claim 55, wherein a length of stay is calculated for each feasible combination.

58. The system of claim 55, wherein the feasible combinations with a length of stay greater than the maximum acceptable length of stay designated by the user is eliminated.

59. The system of claim 55, wherein the feasible combinations with a length of stay less than the minimum acceptable length of stay designated by the user is eliminated.

60. The system of claim 55, further comprising querying means for querying the user for a second set of input data, the second set of input data including selecting at least one acceptable departure airport and at least one acceptable arrival airport associated with the travel departure and arrival.

61. The system of claim 55, further comprising querying means for querying the user for an acceptable maximum number of connections.

62. The system of claim 55, further comprising querying means for querying the user for an acceptable means of sorting and displaying the results of the travel database query.

63. The system of claim 55, further comprising accessing means for accessing a remotely accessible source for making travel destination reservations.

64. The system of claim 55, further comprising making a reservation at a selected travel destination using the remotely accessed source for making travel destination reservations.

65. A method of creating a database to be used in travel product searches, comprising:
inputting information concerning a plurality of travel departure and arrival airports into an information storage and retrieval system for storing, referencing and retrieving the travel departure and arrival airport information; and
inputting information concerning a plurality of travel departure and arrival geography ranges into said information storage and retrieval system for storing, referencing and retrieving the travel departure and arrival geography information.

66. A method for providing online travel reservation services, said method comprising the steps of:
providing a user selectable first date range corresponding to an outbound flight from a first geographic location and a user selectable second date range corresponding to an inbound flight from a second geographic location, wherein each of the first and second date ranges are selectable from one or more calendar days and wherein at least one of the first or second date ranges comprising more than one calendar day; and
generating one or more user selectable combinations of available travel schedules each comprising an outbound flight corresponding to a selected first date range and an inbound flight corresponding to a selected second date range.

67. The method of claim 66, wherein the step of generating one or more user selectable combinations of available travel schedules includes generating one or more user selectable combinations of travel schedules based on one or more user selected date ranges and querying one or more travel databases to determine the availability of the one or more user selectable combinations of travel schedules.

68. The method of claim 66, further comprising presenting the one or more user selectable combinations of available travel schedules to the user.

69. The method of claim 66, further comprising providing the user the ability to reserve a travel schedule from the one or more user selectable combinations of available travel schedules.

70. The method of claim 66, wherein a user selectable date range is one or more dates for departure.

71. The method of claim 66, wherein a user selectable date range is one or more dates for arrival.

72. The method of claim 66, wherein a user selectable date range having more than one calendar day is selected by selecting an earliest date and a latest date.

73. The method of claim 72, wherein selecting an earliest date and a latest date is performed by clicking on a graphical calendar.

74. A method for providing online travel reservation services, said method comprising the steps of:
providing a user selectable first date range corresponding to an outbound flight from a first geographic location and a user selectable second date range corresponding to an inbound flight from a second geographic location, wherein each of the first and second date ranges are selectable from one or more calendar days;
providing a user selectable length of stay; and
generating one or more user selectable combinations of available travel schedules comprising an outbound flight and an inbound flight scheduled between selected first and second date ranges, wherein the length of time between the outbound and inbound flights of each of the one or more travel schedules does not exceed a selected length of stay.

75. The method of claim 74, wherein the step of generating one or more user selectable combinations of available travel schedules includes generating one or more user selectable combinations of travel schedules based on one or more user selected date ranges a selected length of stay and querying one or more travel databases to determine the availability of the one or more user selectable combinations of travel schedules.

76. The method of claim 74, further comprising presenting the one or more user selectable combinations of available travel schedules to the user.

77. The method of claim 74, further comprising providing the user the ability to reserve at least one travel schedule from the one or more user selectable combinations of available travel schedules.

78. The method of claim 74, wherein a user selectable date range is one or more dates for departure.

79. The method of claim 74, wherein a user selectable date range is one or more dates for arrival.

80. The method of claim 74, wherein a user selectable date range having more than one calendar day is selected by selecting an earliest date and a latest date.

81. The method of claim 80, wherein selecting an earliest date and a latest date is performed by clicking on a graphical calendar.

82. An online travel reservation system, said system comprising:
a user interface that allows a user to select a first date range corresponding to an outbound flight from a first geographic location and a second date range corresponding to an inbound flight from a second geographic location, wherein each of the first and second date ranges are selectable from one or more calendar days and wherein at least one of the first or second date ranges comprises more than one calendar day; and
a database coupled to the user interface and configured to store one or more user selectable combinations of available travel schedules each comprising an outbound flight corresponding to a selected first date range and an inbound flight corresponding to a selected second date range.

83. The system of claim 82, wherein the system is coupled to one or more travel databases having information about the availability of one or more combinations of travel schedules.

84. The system of claim 82, wherein the user interface includes a graphical depiction of a calendar having dates, wherein a date range is selected by clicking on one or more dates of the calendar.

85. The system of claim 82, wherein a date range having more than one calendar day is selected by selecting an earliest date and a latest date.

86. A method for providing online travel reservation services, said method comprising the steps of:
providing a user selectable geographic region,
providing a user selectable first date corresponding to an outbound flight from a first geographic location and a user selectable second date corresponding to an inbound flight from a second geographic location, wherein at least one of the first and second geographic locations is a user selected geographic region;
generating one or more user selectable combinations of available travel schedules comprising an outbound flight and an inbound flight scheduled between selected first and second dates and first and second locations.

87. The method of claim 86, wherein the step of generating one or more user selectable combinations of available travel schedules includes generating one or more user selectable combinations of travel schedules based on user selected dates and user selected geographic locations and querying one or more travel databases to determine the availability of the one or more user selectable combinations of travel schedules.

88. The method of claim 86, further comprising presenting the one or more user selectable combinations of available travel schedules to the user.

89. The method of claim 86, further comprising providing the user the ability to reserve a travel schedule from the one or more user selectable combinations of available travel schedules.

90. The method of claim 86, wherein a user selected geographic region includes one or more airports.

91. The method of claim 86, wherein a user selected geographic region is established by selecting a particular country.

92. An online travel reservation system, said system comprising:
a user interface that allows a user to select a geographic region, a first date corresponding to an outbound flight from a first geographic location, and a second date corresponding to an inbound flight from a second geographic location, wherein at least one of the first and second geographic locations is a user selected geographic region;
a database coupled with the user interface and configured to store one or more user selectable combinations of available travel schedules comprising an outbound flight and an inbound flight scheduled between selected first and second dates and first and second locations.

93. The system of claim 92, wherein the system is coupled to one or more travel databases that provide information on the availability of one or more combinations of travel schedules.

94. The system of claim 92, wherein a geographic region includes one or more airports.
